(19) United States
(12) Patent Application Publication
(10) Pub. No.: US 2017/0300701 A1
(43) Pub. Date: Oct. 19, 2017

(54) SECURE AND COMPLIANT EXECUTION OF PROCESSES

(71) Applicant: SAP SE, Walldorf (DE)

(72) Inventors: SERENA PONTA, Antibes (FR); Luca Compagna, Mougins Cedex (FR); Daniel Dos Santos, Valbonne (FR); Silvio Ranise, Trento (IT)

(21) Appl. No.: 15/097,304

(22) Filed: Apr. 13, 2016

(51) Int. Cl. G06F 21/62; G06Q 40/02; G06Q 10/06

(52) U.S. Cl. CPC G06F 21/6218; G06Q 10/06; G06Q 40/025

(57) ABSTRACT

At design time, a process designer may generate a workflow model of a process associated with in-memory database. The workflow model include tasks and authorization constraints. The authorization constraints are task based constraints, associated with the workflow model. The workflow model is translated into transition system format to generate a reachability graph including possible workflow execution paths. The reachability graph may be translated in a database query format to generate a monitor. At runtime, when a request is received from a process participant to execute a specific task in the workflow model, the monitor is able to enforce authorization constraints and authorization policies received at the runtime, and ensure secure and compliant execution of processes.

### FIELD

Embodiments generally relate to data processing, and more particularly to data processing systems and method that facilitate secure and compliant execution of processes.

### BACKGROUND

Computer applications such as enterprise systems execute processes for delivery of services or products. Successful execution of the processes ensures continuity in serving an organizational goal for a particular customer. Best practice in enterprises is to ensure that the processes comply with legal and/or organizational requirements, to prevent disruptive incidents such as fraudulent execution of processes, or issues related to conflict of interest. Failing to comply with the legal and organizational requirements may lead to loss of continuity in serving the organizational goal. For example, consider a complex process such as ‘insurance claim process’ that may include tasks, e.g. ‘claim intimation’, ‘pre-processing’, ‘pre-adjudication’, ‘validation’, ‘post settlement’, and ‘reporting’ that may have multiple workflows to complete the process from start to end. If one of the workflow fails to comply with the legal and/or organizational requirements, continuity in serving the organizational goal may be lost. Solving the continuity issue during runtime may be time consuming, and eventually leads to either cancelation of the processes, or violation of the legal and organizational requirements. In order to maintain the continuity in serving the organizational goal, individual workflows have to be explored at runtime. As a result, a significant amount of time and effort is lost. Therefore, it is a challenge to ensure secure and compliant execution of processes for delivery of services or products, and maintain continuity in serving the organizational goal.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating high level architecture of secure and compliant execution of processes, according to one embodiment.

FIG. 2 is workflow diagram illustrating secure and compliant execution of a process, according to one embodiment.

FIG. 3 is a flow diagram illustrating translation of workflow model into a transition system format, according to one embodiment.

FIG. 4A is code snippet illustrating a backward reachability procedure to generate a reachability graph, according to one embodiment.

FIG. 4B is a flow diagram illustrating graphical representation of a reachability graph of a workflow, according to one embodiment.

FIG. 5 is a block diagram illustrating a computer system for generating a monitor during design time, according to one embodiment.

FIG. 6 is a flow diagram illustrating execution environment implementing a monitor during runtime to ensure secure and compliant execution of process, according to one embodiment.

FIG. 7 is a flow diagram illustrating generation of a workflow model by a process designer during design time, according to one embodiment.

FIG. 8A-8C in combination are graphical user interfaces (GUI's) illustrating status of execution of processes at runtime, according to one embodiment.

FIG. 9A is a flow diagram 900 illustrating generation of a monitor at design time, according to one embodiment.

FIG. 9B is a flow diagram illustrating secure and complaint execution of processes by enforcing authorization constraints and authorization policies at runtime, according to one embodiment.

FIG. 10 is a block diagram of an exemplary computer system, according to one embodiment.

### DETAILED DESCRIPTION

Embodiments of techniques for secure and compliant execution of processes are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”. “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

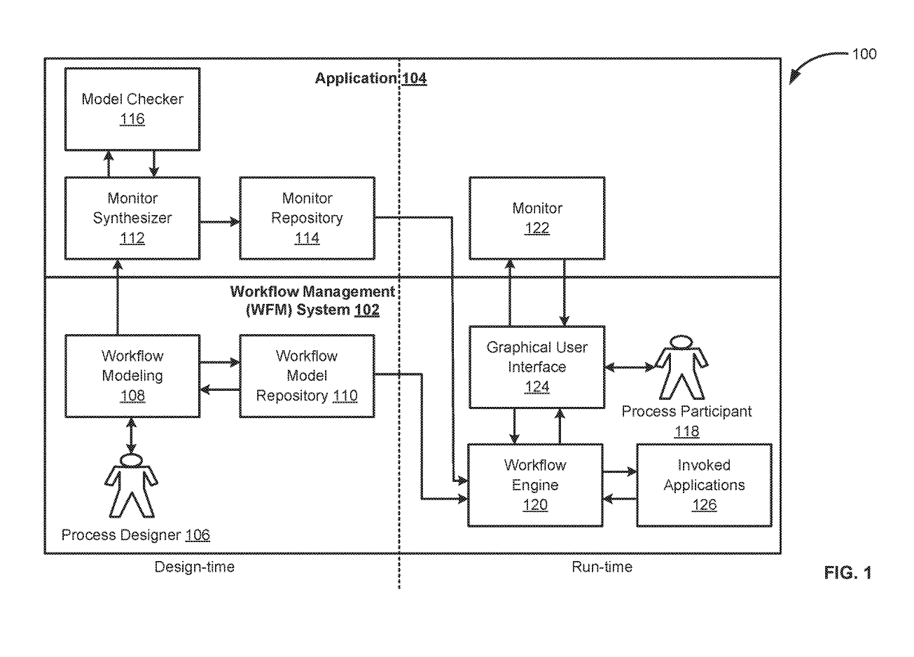

FIG. 1 is a block diagram 100 illustrating high level architecture of secure and compliant execution of processes, according to one embodiment. An enterprise computer application such as ‘workflow management (WFM) system’ 102, may execute processes that involve execution of sequential activities or tasks, non-sequential activities etc. Successful execution of a process may serve an organizational goal. ‘WFM system’ 102 may include security sensitive process that has to comply with the legal and organizational requirements, based on authorization policies and authorization constraints. The authorization policies define assignment of users to execute specific tasks during runtime. The users executing tasks during runtime may be referred as process participants. The authorization policies may also include various authorization rules, permissions, roles, identity, group, etc., associated with the users. For example, there may be a set of process participants (U) such as U={A, B, C, D} and a set of tasks such as (T)={t₁, t₂, t₃, t₄, t₅}. If there are ‘n’ number of tasks then at least ‘k’ different users are needed to complete the task, satisfying the condition (k≦n). An administrator may define authorization policies such as (P)={(t₁, A), (t₁, B), (t₁, C), (t₂, A), (t₂, B), (t₂, C), (t₃, A), (t₃, B), (t₄, B), (t₄, C), (t₅, A)}. The ‘process participant A’, ‘process participant B’ and ‘process participant C’ are authorized to execute task (t₁), and ‘process participant A’, ‘process participant B’ and ‘process participant C’ are authorized to execute task (t₂), and the like.

The authorization constraints include task specific constraints that may include separation of duty (SoD) constraints, binding of duty (BoD) constraints, role constraints, temporal constraints, etc. In the context of process, SoD constraints may enforce conflict of interest constraints. For example, a SoD constraint may be represented as {((t₁, t₂), ≠)}, this means that if the ‘process participant A’ has executed task(t₁) then ‘process participant A’ may not be allowed to execute task (t₂). Based on the authorization policy (P), ‘process participant B’ may be allowed to execute task (t₂). The BoD constraints include subject-binding constraints and role-binding constraints. The subject-binding constraints define that if a ‘process participant’ execute a first task then the ‘process participant’ may also be allowed to execute tasks associated with the first task. For example, a BoD constraint may be {((t₁, t₃), =)}, this means that if ‘process participant A’ has executed task (t₁) then ‘process participant A’ may be also allowed to execute task (t₃). Role-binding constraints define that process participants with identical user roles may be allowed to execute the tasks associated with the first task. For example, the BoD constraint {((t₁, t₃), =)}, if ‘process participant A’ is allowed to execute task (t₁) and ‘process participant B’ is allowed to execute task (t₂), then ‘process participant A’ and ‘process participant B’ may have identical user roles.

The ‘WFM system’ 102 may be integrated with ‘application’ 104 to ensure secure and compliant execution of the processes. The ‘WFM system’ 102 and ‘application’ 104 may be using in-memory database to process data. The ‘application’ 104 may be an enterprise application that ensures successful execution of workflows associated with the processes while enforcing authorization policies, and authorization constraints. For example, ‘application’ 104 may be SAP® Cerberus. The ‘WFM system’ 102 and the ‘application’ 104 may include functionalities that are designed during design time and executed during runtime.

At design time, a user referred as ‘process designer’ 106 may access ‘workflow modeling’ 108 to design, and generate a workflow model for a process. The workflow model for the process is generated using a process model language or a process model and notation language. For example, the ‘process designer’ 106 may design workflow model for a process ‘travel itinerary’ that may include tasks such as ‘trip request (t₁)’. ‘car rental (t₂)’, ‘hotel booking (t₃)’, ‘≠light reservation (t₄)’ and ‘trip validation (t5)’. The ‘process designer’ 106 may also input authorization policies such as (P)={(t₁, A), (t₁, B), (t₁, C), (t₂, A), (t₂, B), (t₂, C), (t₃, A), (t₃, B), (t₄, B), (t₄, C), (t₅, A)}, and authorization constraints such as AC={((t₁, t₂), ≠), ((t₂, t₅), ≠), ((t₂, t₃), ≠), ((t₃, t₅), ≠), ((t₁, t₄), ≠)} associated with the workflow model generated. The ‘process designer’ 106 may also provide the authorization policies (P) during runtime. The ‘workflow modeling’ 108 may be connected with ‘workflow model repository’ 110. The ‘workflow modeling’ 108 is a graphical user interface for the ‘process designer’ 106 to design workflows. The workflow model ‘S’ generated by the process designer 106 may be stored in the ‘workflow model repository’ 110.

‘Monitor synthesizer’ 112 of the ‘application’ 104, may receive the workflow model generated by the ‘workflow modeling’ 108. The workflow model may be received in the form of graphical representation. For example, the graphical representation of the workflow model may be a XML code. The ‘monitor synthesizer’ 112 may translate the workflow model into a transition system format that may be acceptable by ‘model checker’ 116. The workflow model may be translated into the transition system format using mathematical modeling languages, e.g. Petri net or place/transition net, etc. The ‘model checker’ 116 may be connected with the ‘monitor synthesizer’ 112 to receive the workflow model. The ‘model checker’ 116 may apply backward reachability procedures to generate a reachability graph for the workflow model received in the form of transition system format. The backward reachability procedures may be algorithms including a set of instructions to generate a reachability graph that has the ability to trace a workflow execution path from an initial state to a final state and vice versa. The reachability graph may include possible workflow execution paths in the process.

The reachability graph includes nodes representing states and edges representing execution of a task by a ‘process participant’ 118. The ‘monitor synthesizer’ 112 may translate the reachability graph in a database query format, e.g. structured query language (SQL) or Datalog to be stored in the ‘monitor repository’ 114. The reachability graph is translated to generate a ‘monitor’ 122 that may be referred as an enforcement mechanism. The ‘monitor’ 122 is capable of ensuring successful execution of tasks associated with the process by enforcing the authorization constraints and authorization policies based on the reachability graph. The ‘monitor’ 122 may be able to support multiple authorization policies during runtime.

At runtime, the ‘workflow engine’ 120 may receive the workflow model and the ‘monitor 122’ as input from the ‘workflow model repository’ 110 and ‘monitor repository’ 114. The ‘workflow engine’ 120 may receive requests from the ‘process participant’ 118 to execute the task associated with the process in the ‘graphical user interface’ (GUI) 124 connected with the ‘workflow engine’ 120. The GUI 124 may query the ‘monitor’ 122 based on the requests received from the ‘process participant’ 118. The GUI 124 may be a web interface, e.g. web task management dashboard, accessible by the authorized ‘process participant’ 118. For example, the ‘process participant’ 118 may request for the task ‘car rental (t₂)’ after execution of the task ‘trip request (t₁)’. The ‘workflow engine’ 120 may invoke the ‘monitor’ 122 based on the request received from the ‘process participant’ 118. The GUI 124 may query the ‘monitor’ 122 based on the authorization constraints and the authorization policies to enforce successful execution of the requested task, i.e. ‘car rental (t₂)’, by the ‘process participant’ 118. Based on the ‘process participant’ 118 request, ‘monitor’ 122 may be queried and provide either “request grant” or “request deny” as an output to be displayed in the GUI 124. ‘Process participant’ 118 may receive “request grant” in the GUI 124 to execute the task ‘car rental (t₂)’ based on the authorization policies and authorization constraints. In another example, ‘process participant B’ may request to execute the task ‘trip validation (t₅)’ after successful execution of the task ‘car rental (t₂)’, in the GUI 124. The ‘monitor’ 122 may be queried to enforce the authorization policies and authorization constraints, and provide “request deny” to ‘process participant B’ in the GUI 124.

Based on the workflow model, the ‘workflow engine’ 120 may also direct execution of tasks, e.g. computer system tasks, scripting or coding tasks, etc., to the invoked applications 126, using procedure calls, e.g. structured query language (SQL) procedure call. The ‘workflow engine’ 120 may invoke the ‘monitor’ 122, when the ‘process participant’ 118 is required to execute the tasks associated with the workflow model. Therefore, secure and compliant execution of the workflow model ensures continuity in serving the organizational goal.

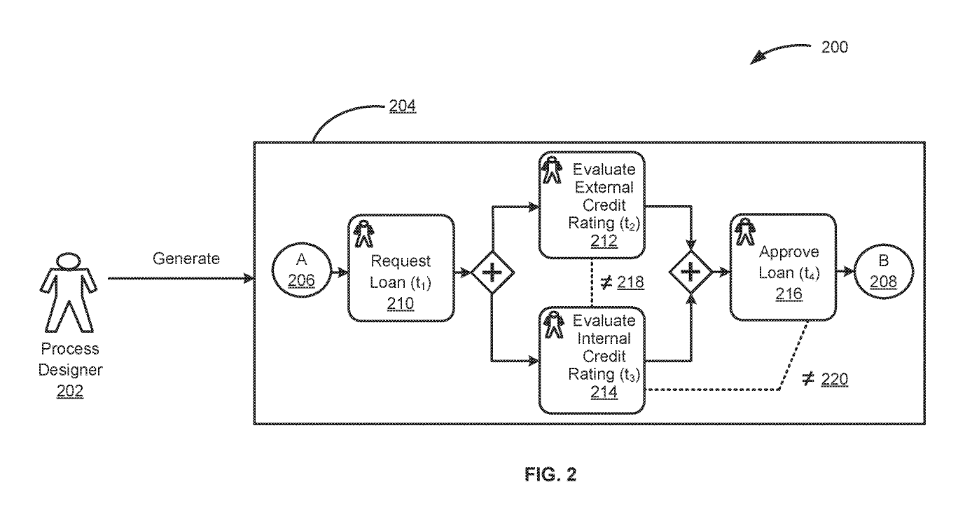

FIG. 2 is workflow diagram 200 illustrating secure and compliant execution of a process, according to one embodiment. During design time, ‘process designer’ 202 may access ‘WFM system’ to generate ‘workflow model’ 204 for a process, e.g. ‘loan origination process’. The ‘workflow model’ 204 may be generated to serve an organizational goal. The symbol ‘A’ 206 and ‘B’ 208 represent ‘start’ and ‘end’ of the ‘loan origination process’. The ‘workflow model’ 204 may include tasks 210 to 216 such as ‘request loan (t₁)’ 210, ‘evaluate external credit rating (t₂)’ 212, ‘evaluate internal credit rating (t₃)’ 214 and ‘approve loan (t4)’ 216. In addition, the ‘process designer’ 202 may also provide ‘authorization constraints’ such as SoD constraints and BoD constraints applicable to the ‘workflow model’ 204. There are two SoD constraints 218 and 220 represented by symbol ‘≠’. The SoD constraints 218 and 220 may define criteria for conflict of interest, and prevents a user, e.g. process participant from executing two different tasks. For example, SoD 218 prevents the ‘process participant A’ from executing task ‘evaluate internal credit rating (t₃)’ 214 after successful execution of task ‘evaluate external credit rating (t₂)’ 212 and vice versa. In another example, the SoD 220 may prevent the ‘process participant’ from executing the task ‘approve loan (t₄)’ 216 after successful execution of the task ‘evaluate internal credit rating (t₃)’ 214.

At design time, in one embodiment, the number of process participants required to execute the tasks in the ‘workflow model’ 204 may depend on the number of tasks included in the ‘workflow model’ 204. For example, if there are ‘n’ number of tasks in the ‘workflow model’ 204, then ‘k’ number of process participants are required to execute ‘n’ number of the tasks, and satisfy a condition (k≦n). Accordingly the ‘workflow model’ 204 may require three process participants, e.g. ‘process participant A’, ‘process participant B’ and ‘process participant C’ to execute the four tasks 210 to 216 in the ‘loan origination process’. In another embodiment, the minimum number of process participants required to execute the tasks in the ‘workflow model’ 204 may also depend on the number of ‘authorization constraints’ associated with the ‘workflow model’ 204. For example, since there are two SoD constraints 218 and 220, the minimum number of process participants required to execute the ‘workflow model’ 204 may be two. Accordingly the ‘process participant A’ may execute the tasks ‘evaluate external credit rating (t₂)’ 212 and ‘approve loan (t₄)’ 216 while ‘process participant B’ may execute the tasks ‘request loan (t₁)’ 210 and ‘evaluate internal credit rating (t₃)’ 214.

During runtime, the ‘process designer’ 202 or an administrator may also input ‘authorization policies’ to indicate assignment of process participants to execute specific tasks. The number of process participants provided in the ‘authorization policies’ at runtime may be different from the number of process participants determined to execute the tasks in the ‘workflow model’ 204 at design time. The ‘authorization policies’ may include assignment of the ‘process participant A’, ‘process participant B’, and ‘process participant C’ to execute the tasks (t₁ to t₄) in the ‘workflow model’ 204. For example, the ‘process designer’ 202 or an administrator may input ‘authorization policies’, as shown below in table 1. The ‘authorization policies’ shown in table 1 may be for the ‘loan origination process’.

TABLE 1
Authorization policy

| Policies | Tasks | Process Participants |
|---|---|---|
| p1 | t₁ | A, B, C |
| p2 | t₂ | A, B, C |
| p3 | t₃ | A, B |
| p4 | t₄ | A |

According to the ‘authorization policies’ (p1) to (p4): (p1) the ‘process participant A’, ‘process participant B’, and ‘process participant C’ are authorized to execute the ‘request loan (t₁)’ 210; (p2) the ‘process participant A’, ‘process participant B’, and ‘process participant C’ may be authorized to execute the ‘evaluate external credit rating (t₂)’ 212; (p3) the ‘process participant A’ and ‘process participant B’ are authorized to execute the ‘evaluate internal credit rating (t₃)’ 214; and (p4) the ‘process participant A’ is authorized to execute the ‘approve loan (t₄)’ 216.

Based on the ‘authorization policies’, the ‘process participant A’ may be allowed to execute the task ‘request loan (t₁)’ 210, and the ‘process participant B’ may request execution of the task ‘evaluate external credit rating (t₂)’ 212. The ‘process participant B’ may be allowed to execute the requested task ‘evaluate external credit rating (t₂)’ 212, since, the ‘process participant B’ has not executed tasks earlier, associated with SoD constraints. Next, the ‘process participant A’ may be allowed to execute ‘evaluate internal credit rating (t₃)’ 214 and satisfy the SoD constraint 218. However, no process participants may be available to execute the ‘approve loan (t₄)’ 216 and also satisfy the SoD constraint 220, and the ‘authorization policies’. As a result, when the task ‘approve loan (t₄)’ 216 is not executed, this may either lead to loss of continuity or violation of ‘authorization policies’ in completing execution of the ‘loan origination process’. Loss of continuity of the process implies an unsuccessful execution of the ‘workflow model’ 204.

The ‘process designer’ 202 may change or insert, or delete ‘authorization policies’ during runtime. The ‘workflow model’ 204 and the existing ‘authorization constraints’ may be used with different ‘authorization policies’ during runtime. For example, two banks may implement the ‘loan origination process’ that include identical ‘authorization constraints’ and tasks (t₁) to (t₄) but different ‘authorization policies’ for different process participants.

Successful execution of the ‘workflow model’ 204, e.g. the ‘loan origination process’, ensures workflow satisfiability. The workflow satisfiability is defined as execution of the tasks associated with the ‘workflow model’ 204 by the process participants, based on the ‘authorization policies’, satisfying the ‘authorization constraints’. For example, the successful execution of the ‘loan origination process’ may involve successful execution of all the tasks (t₁ to t₄) without violating the ‘authorization constraints’ 204 such as SoD 218 and 220, and also satisfying all the ‘authorization policies’ as shown in table 1.

Based on the ‘authorization policies’, the ‘workflow model’ 204 may include following valid workflow execution paths as examples. In workflow execution path-I, ‘process participant C’ may execute the ‘request loan (t₁)’ 210, ‘process participant A’ may execute the ‘evaluate external credit rating (t₂)’ 212, ‘process participant B’ may execute the ‘evaluate internal credit rating (t₃)’ 214, and ‘process participant A’ may execute the ‘approve loan (t₄)’ 216. In workflow execution path-II, ‘process participant A’ may execute the ‘request loan (t₁)’ 210, ‘process participant B’ may execute the ‘evaluate internal credit rating (t₃)’ 214, ‘process participant C’ may execute the ‘evaluate external credit rating (t₂)’ 212, and ‘process participant A’ may execute the ‘approve loan (t₄)’ 216.

In the above examples, ‘workflow execution path-I’ and ‘workflow execution path-II’ ensure workflow satisfiability, since, all the tasks (t₁) to (t₄) are successfully executed based on the ‘authorization policies’, and also satisfying the SoD constraints 218 and 220. Therefore, secure and compliant execution of the ‘workflow model’ 204 of the process, ensures continuity in serving the organization goal.

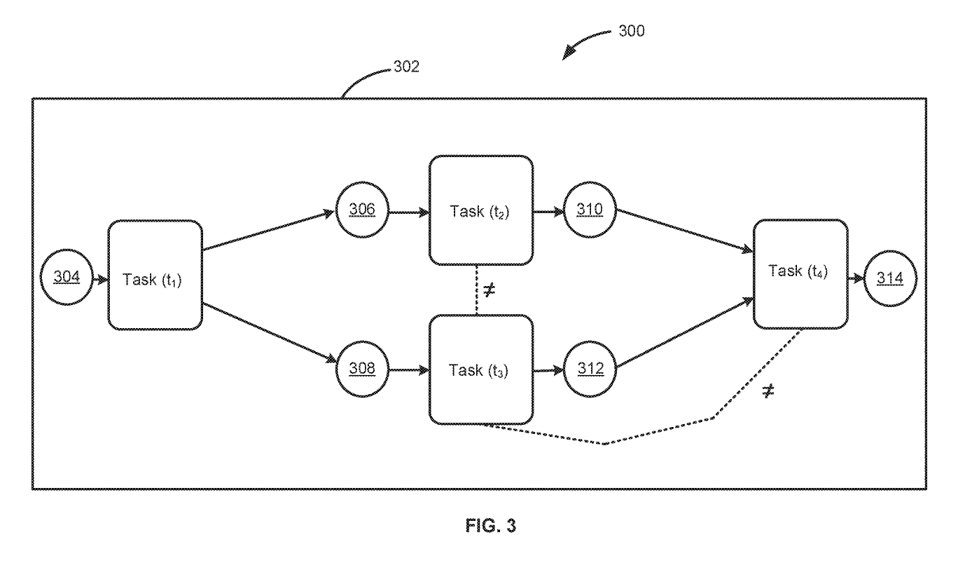

FIG. 3 is flow diagram 300 illustrating translation of workflow model into a transition system format, according to one embodiment. A ‘process designer’ may generate a ‘workflow model’, e.g. ‘loan origination process’. The ‘loan origination process’ may include tasks such as ‘request loan (t₁)’, ‘evaluate external credit rating (t₂)’, ‘evaluate internal credit rating (t₃)’, and ‘approve loan (t₄)’. The ‘process designer’ may also input the ‘authorization constraints’ such as SoD constraints and BoD constraints applicable to the ‘workflow model’. The ‘authorization constraints’ are represented by the symbol ‘≠’. During design time, the ‘workflow model’ may be translated into ‘transition system format’, shown in block 302. The ‘workflow model’ may be translated into ‘transition system format’ 302 using mathematical modeling languages, e.g. Petri net.

The ‘transition system format’ 302 may be a graphical representation of the ‘workflow model’ in which tasks (t₁) to (t₄) may be referred as transitions or events and ‘positions’ 304 to 314 may be referred as enabling conditions for execution of the tasks (t₁) to (t₄), as shown in the FIG. 3. The ‘transition system format’ 302 of the ‘workflow model’ satisfies condition that there may exists at most one token in the ‘positions’ 304 and 314. For example, when a task (t) from the list of tasks (t₁) to (t₄) could not be executed, corresponding position may include zero token. When the task (t) from the list of tasks (t₁) to (t₄) could be executed, then corresponding position may include one token. Based on number of tasks associated with previously executed task, number of tokens in subsequent transitions may increase or decrease. A token may be allocated to ‘position’ 304 to enable execution of the task (t₁). Task (t₁) may be executed satisfying condition that defines as execution of task (t₁) before execution of other tasks (t₂) to (t₄) in the ‘workflow model’. Execution of the task (t₁), removes the token from the ‘position’ 304 and allocate tokens to ‘position’ 306 and 308. This enables the execution of the tasks (t₂) and (t₃) and satisfies another condition that defines that tasks (t₂) may be executed before task (t₃), or vice versa, after execution of the task (t₁) and before execution of the task (t₄). After, execution of the tasks (t₂) and (t₃), remove tokens from the ‘positions’ 306 and 308, and allocate tokens to ‘positions’ 310 and 312. This enables the execution of the task (t₄). Execution of the task (t₄), remove tokens from the ‘positions’ 310 and 312 and allocates token to ‘position’ 314 that may define end of the ‘workflow model’ or no further transitions. Task (t₄) may be executed satisfying another condition that defines as task (t₄) may be the last task to be executed of the ‘workflow model’.

As an exemplary embodiment, execution of the tasks (t₁) to (t₄) may be shown in the form of Boolean expressions, as shown in table-II below. Successful execution of the task (t) may be represented as ‘dₜ’. The enabling condition (p0) at ‘position’ 304 that satisfies the condition on task (t₁) may be expressed as (p0 [symbol] dₜ₁), this means that the token is at ‘position’ 304 and execution of task (t₁) is yet to occur. When task (t₁) is executed, it may be referred as true (T) else false (F). Functions ‘aₜ’ and ‘hₜ’ may be introduced for the execution of tasks (t₁) to (t₄). The function ‘aₜ’ defines a function that behaves as an abstract interface to ‘authorization policies’ provided by the ‘process designer’. The ‘process designer’ may input the ‘authorization policies’ either during design time or during runtime. The function aₜ(u) is true, if a ‘process participant (u)’ is allowed to execute the task (t). The function ‘hₜ’ defines execution history of the tasks (t₁) to (t₄) by ‘process participant (u)’. The function hₜ(u) is true, if the ‘process participant (u)’ has executed the task (t). According to table 2, enabling condition (p0) is associated with the ‘position’ 304; enabling condition (p1) is associated with the ‘position’ 306; enabling condition (p2) is associated with the ‘position’ 308; enabling condition (p3) is associated with the ‘position’ 310; enabling condition (p4) is associated with the ‘position’ 312; and enabling condition (p5) is associated with the ‘position’ 314.

TABLE 2

| | |
|---|---|
| Enabled Execution | Action |

| | Execution | Authorization | Workflow | Authoriza- |
|---|---|---|---|---|
| Transition | Conditions | Constraints | Execution | tion |
| t₁(u) | p0 \hat{ } [symbol] dₜ₁ | aₜ₁(u) | p0, p1, p2, dₜ₁ | hₜ₁(u) := T |
| | | | := F, T, T, T, | |
| | | | T, T | |
| t₂(u) | p1 \hat{ } [symbol] dₜ₂ | aₜ₂(u) \hat{ } [symbol] hₜ₃ | p1, p3, dₜ₂ | hₜ₂(u) := T |
| | | | := F, T, T | |
| t₃(u) | p2 \hat{ } [symbol] dₜ₃ | aₜ₃(u) \hat{ } [symbol] hₜ₂ | p2, p4, dₜ₃ | hₜ₃(u) := T |
| | | | := F, T, T | |
| t₄(u) | p3 \hat{ } p4 \hat{ } p5 \hat{ } | aₜ₄(u) \hat{ } [symbol] hₜ₃ | p3, p4, p5, dₜ₄ | hₜ₄(u) := T |
| | [symbol] dₜ₄ | | := F, F, T, T | |

In the above table 2, first column represents name of the transitions i.e. tasks (t₁ to t₄) that depends on the ‘process participant’ (u). Second column shows the ‘enabled execution’ of the tasks (t₁) to (t₄). This column is divided into two, such as ‘execution constraints’ and ‘authorization constraints’. Third column represents ‘workflow execution’ of the transitions. Fourth column represents authorization of the ‘process participant (u)’ based on the ‘authorization constraints’ and ‘authorization policies’. Based on the ‘transition system format’ 302, a reachability graph for the ‘workflow model’ may be generated.

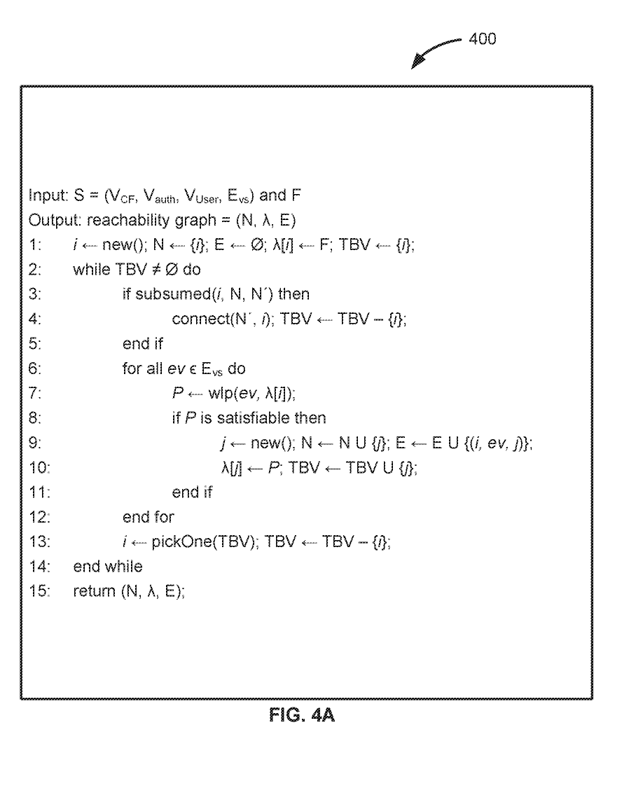

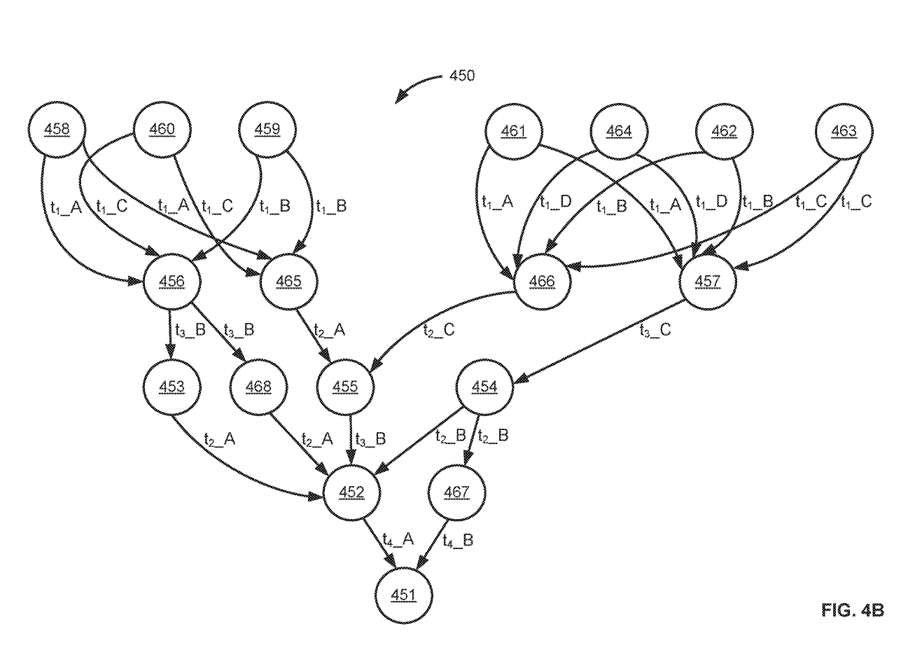

FIG. 4A is code snippet 400 illustrating a backward reachability procedure to generate a reachability graph, according to one embodiment. A ‘process designer’ may input ‘workflow model S’ in a computer application that executes the backward reachability procedure code snippet 400. The code snippet 400 may be able to derive ‘State formula F’ from the ‘workflow model S’ received. The ‘state formula F’ defines a set of final states in which all the tasks associated with the ‘workflow model S’ has been executed successfully. The ‘workflow model S’ may include sets of variables ‘V_{CF}’, ‘Vₐᵤₜₕ’, ‘Vᵤₛₑᵣₛ’, ‘E_{VS}’. The variable set ‘V_{CF}’ represents execution conditions defined as enabling condition for a position in a transition system format of the ‘workflow model S’. The tasks included in the ‘workflow model S’ are represented as transitions (tr) in the transition system format. The variable set ‘Vₐᵤₜₕ’ represents conditions: if a ‘process participant’ is allowed to execute a task, and if the task has been executed by the ‘process participant’. The variable set ‘Vᵤₛₑᵣₛ’ represents a set of process participants mapped to execution of tasks associated with the ‘workflow model S’. The reachability graph may include a set of labeled workflow execution paths of the ‘workflow model S’ ending with ‘F’. The variable set ‘Eᵥₛ’ represents events in the transition format system. The code snippet 400 may incrementally build the reachability graph by adding a node to a set of nodes ‘N’ and an edge to a set of edges ‘E’. The nodes in ‘N’ may be labeled by using a labeling function ‘λ’. In line 1, a new node ‘i’ is created by invoking a first auxiliary function ‘new’ that returns a new node distinct from nodes included in ‘N’, at each invocation of the first auxiliary function ‘new’. Initialize the set of edges ‘E’ as empty set. The new node ‘i’ is assigned to the set of nodes ‘N’, and labeled by the labeling function ‘λ[i]’. There is also another set of nodes, named as to-be-visit (TBV) nodes, and may be initialized by assigning the new node ‘i’. The TBV nodes may be modified at each iteration by removing the node visited in the current iteration and adding new nodes obtained by applying transitions (tr) in the ‘workflow S’ to the set of nodes ‘N’. In lines 2 to 15, a set of steps are iteratively repeated for every TBV nodes. At each iteration ‘i’, the main loop checks whether there are states identified as weakest liberal precondition (WLP) of the labeling function λ[i] with respect to the events ‘Eᵥₛ’ included in the union of the states that are already generated, according to line 3. The WLP is defined as a function for current set of states ‘s’ corresponding to the transition (tr). The WLP returns a set of states ‘r’ to which the transition (tr) may be applied to reach the current set of states ‘s’. Function ‘subsumed (i, N, N′)’ may be invoked with a current node ‘i’. The function ‘subsumed (i, N, N′)’ may return true if there exists a subset ‘N′’ of ‘N/{i}’ such that the logical disjunction of all λ[j] for every ‘j’ in ‘N′’ is a logical implication of WLP(tr, λ[i]). The ‘j’ iteration checks if a new state is included in the current set of states ‘s’. In one embodiment, a new node ‘v’ may not be included in the set of nodes ‘N’. This is because an edge that is used to arrive at new node ‘v’ may already be generated when visiting the nodes in ‘N′’. Therefore, the current node ‘i’ may be removed from the set of TBV nodes, and a new node ‘j’ may be labeled by WLP(tr. λ[i]) and a new edge from node ‘j’ to node ‘i’ is labeled as transition (tr) is generated. This is accomplished by initiating the second iteration and invoking a second auxiliary function ‘connect’, as mentioned in line 3. If the node ‘i’ is not ‘subsumed’ by the set of nodes ‘N’, then the function subsumed (i, N) returns false. In another embodiment, WLP for the transitions (tr) in the set of events ‘ev’ may be computed as WLP(ev, λ[i]) and used to label new nodes ‘j’, according to lines 6 to 7. Next, each new node ‘j’ may be verified to determine if it identifies a non-empty set of states. This is done by verifying the logical satisfiability of the formula WLP(ev, λ[i]) for each ‘j’. In another embodiment, a new node ‘j’ may be included in the set of nodes ‘N’ labeled by WLP(tr, λ[i]). An edge may be drawn from ‘i’ to ‘j’ and labeled by ‘tr’. The created node ‘j’ may be added to the set of TBV nodes. If the set of TBV nodes to be visited are non-empty, then a third auxiliary function ‘pickone(TBV)’ may be invoked to visit another node. The ‘pickone(TBV)’ function may select another node from the set of TBV nodes, as mentioned in line 13. In lines 8 to 11, may continue iteratively until the set of TBV nodes is empty. At each iteration a node is removed and eventually reaches a terminating point that corresponds to completion of the reachability graph. When the terminating point is reached, no new nodes are added to the set of nodes ‘N’ because no further transitions (tr) are available in the ‘workflow model S’ that may be applied to the formula WLP(ev, λ[i]). According to the backward reachability procedure, the reachability graph is complete, when the terminating point is reached and all the transitions (tr) associated with the ‘workflow model S’ are executed by the process participants satisfying the execution conditions ‘V_{CF}’ and the conditions ‘Vₐᵤₜₕ’.

FIG. 4B is a flow diagram illustrating graphical representation of a reachability graph 450 of a workflow model, according to one embodiment. A ‘process designer’ may generate the ‘workflow model’ of a process, e.g. ‘loan origination process’. The ‘workflow model’ may include tasks (t), e.g. ‘request loan (t₁)’, ‘evaluate external credit rating (t₂)’, ‘evaluate internal credit rating (t₃)’, and ‘approve loan (t₄)’. The ‘reachability graph’ 450 may be generated based on backward reachability procedures.

The ‘reachability graph’ 450 may include nodes 451 to 468. The nodes 451 to 468 may represent a set of states in the ‘workflow model’. For example, the node 458 represents a state in which ‘process participant A’ has not executed the task (t₁) and node 456 represents the state in which the ‘process participant A’ has executed the task (t₁) and the like. The ‘reachability graph’ 450 also includes edges representing execution of tasks by process participants, referenced by ‘tₓ_{_}y’. The ‘tₓ’ may represent task number, e.g. ‘request loan (t₁)’, ‘evaluate external credit rating (t₂)’, ‘evaluate internal credit rating (t₃)’, and ‘approve loan (t₄)’. The ‘y’ in the edge representation ‘tₓ_{_}y’ may represent ‘process participant y’. For example, edge ‘t₁_{_}B’ represents that the task (t₁), e.g. ‘request loan (t₁)’, may be executed by ‘process participant B’. The node 451 is the root node with no outgoing edges. The root node may represent the states with complete workflow execution of the ‘workflow model’. For example, node 451 may represent successful execution of all the tasks (t₁ to t₄) in the ‘loan origination process’. The nodes 458 to 464 may represent initial states with no incoming edges, e.g. node 408 may represent states when none of the tasks (tₜ to t₄) are executed in the ‘loan origination process’.

The ‘reachability graph’ 450 includes possible workflow execution paths that may include nodes and edges to represent successful execution of the tasks (t₁ to t₄) in the ‘workflow model’. The workflow execution path may start from one of the initial states e.g. leaf node 458 or node 460 and ends at the root node, e.g. node. For example, one of the workflow execution path may include nodes {458, 456, 453, 452, 451} and edges {t₁_{_}A, t₃_{_}B, t₂_{_}A, t₄_{_}A}. For example, if the ‘workflow model’ includes sequential execution of ‘n’ number of tasks then the possible workflow execution path may include ‘n+1’ number of nodes and ‘n’ number of edges. The number of nodes in the workflow execution path is ‘n+1’ because the execution of the ‘workflow model’ starts from the state when none of the tasks are executed and ends at the state when all the tasks are successfully executed. In the ‘loan origination process’ as there are four tasks (t₁ to t₄) in the ‘loan origination process’, the possible workflow execution paths may include five nodes and four edges.

In an exemplary embodiment, the ‘reachability graph’ 450 is for a ‘workflow model’ that includes sequential and parallel execution of tasks. Height or depth of the ‘reachability graph’ 450 i.e. the distance between the initial nodes to the root node is equivalent to the ‘n’ number of tasks in the ‘workflow model’. All the possible workflow execution paths of the ‘workflow model’ complies with the ‘authorization constraints’ provided by the ‘process designer’. For example, the ‘loan origination process’ may include ‘authorization constraints’ between the tasks (t₂) and (t₃), and between the tasks (t₃) and (t₄). Therefore, the workflow execution path may not include edges that shows subsequent execution of the tasks (t₂) and (t₃) or tasks (t₃) and (t₄) by the same ‘process participant’. The workflow execution path may include edges that show subsequent execution of the tasks (t₁) and (t₃) or tasks (t₂) and (t₄) by the same ‘process participant’, since, there are no SoD constraints that exists between the tasks (t₁) and (t₃) or tasks (t₂) and (t₄).

The maximum number of process participants required to execute the tasks (tₓ) may be directly proportional to the ‘n’ number of tasks in the ‘workflow model’. For example, the ‘reachability graph’ 450 include four ‘process participant A’ to ‘process participant D’ to execute the tasks (t₁ to t₄). Also, the number of process participants required to execute the tasks in the workflow execution path may depend on the number of ‘authorization constraints’ in the ‘workflow model’.

In an exemplary embodiment, the ‘reachability graph’ 450 may be incrementally generated according to the backward reachability procedures. First, a node 451 is generated and labeled by the ‘state formula F’ representing a set of final states that allocate tokens to ‘positions’ of transition system format of the ‘workflow model’. Once the node 451 may be assigned or added to a set of TBV nodes, the backward reachability procedures may initiate iteration for generating set of nodes ‘N’, i.e. the set of nodes ‘N’ corresponds to the nodes 451 to 468, shown in FIG. 4B, of the ‘reachability graph’ 450. A current node may not be subsumed by the set of nodes ‘N’, so the backward reachability procedure may apply on all possible transitions (tr) of the ‘workflow model’. The transitions (tr) that are successfully applied by identifying non-empty set of states, e.g. t₄_{_}A and t₄_{_}B, i.e. ‘process participant A’ and ‘process participant B’ are authorized to execute task (t₄), satisfying formulae WLP(t₄_{_}A, F) and WLP(t₄_{_}B, F). For example, nodes 452 and 467 may be generated and labeled by the formulae WLP(t₄_{_}A, F) and WLP(t₄_{_}B, F). In addition, nodes 452 and 467 may be connected to the node 451 by edges labeled as t₄_{_}A and t₄_{_}B. The newly generated nodes are added to the set of TBV nodes while node 451 is removed from the set of TBV nodes.

After completion of the first iteration, one node is chosen from the set of TBV nodes, e.g. nodes 452 and 467, to initiate the next iteration. The backward reachability procedure stops generating nodes when a terminating point is reached i.e., when the set of TBV nodes is empty. When the terminating point is reached, attempts are made to apply the formula WLP(tr, λ[i]) on the transitions (tr) associated with nodes 458 to 464 with no incoming edges, and returns false.

The number of process participants introduced during the generation of the ‘reachability graph’ 450 may not be equivalent to the number of users in the ‘authorization policies’ provided by the ‘process designer’ during runtime. During runtime, the workflow execution path that satisfies the ‘authorization constraints’ and the ‘authorization policies’ may be selected for successful execution of the ‘workflow model’. For example, one of the workflow execution path may include nodes {464, 466, 455, 452, 451} and edges {t₁_{_}D, t₂_{_}C, t₃_{_}B, t₄_{_}A}. The ‘process participant A’ to ‘process participant D’ are required to execute the tasks (t₁ to t₄). In another example, the workflow execution path may include nodes (459, 456, 468, 452, 451) and edges {t₁_{_}B, t₃_{_}B, t₂_{_}A, t₄_{_}A}, ‘process participant A’ and ‘process participant B’ are required to execute the tasks (t₁ to t₄). Based on the ‘reachability graph’ 450, a ‘monitor’ may be generated in database query format, e.g. SQL. The ‘reachability graph’ 450 may be translated into database query format, the translated ‘reachability graph’ 450 may be referred as ‘monitor’. The ‘monitor’ may enforce the ‘authorization constraints’ and ‘authorization policies’ during runtime based on the reachability graph generated.

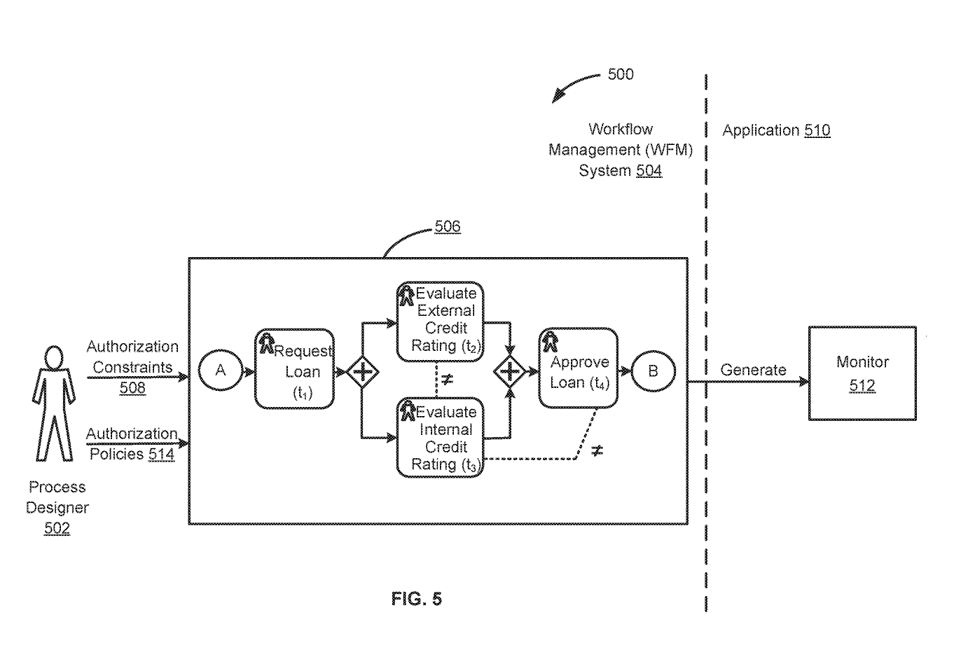

FIG. 5 is a block diagram illustrating a computer system 500 for generating a monitor during design time, according to one embodiment. During design time, a ‘process designer’ 502 may use ‘workflow modeling’ of an ‘enterprise application’, e.g. ‘workflow management (WFM) system’ 504 to generate ‘workflow model’ 506. For example, the ‘workflow model’ 506 may be ‘loan origination process’. The ‘loan origination process’ may include tasks such as ‘request loan (t₁)’, ‘evaluate external credit rating (t₂)’, ‘evaluate internal credit rating (t₃)’, and ‘approve loan (t₄)’. The ‘process designer’ 502 may also input the ‘authorization constraints’ 508 such as SoD constraints and BoD constraints, applicable to the ‘workflow model’ 506. ‘Application’ 510 may receive the ‘workflow model’ 506 from the ‘WFM system’ 504, and generates ‘monitor’ 512 for the ‘workflow model’ 506. The ‘monitor’ 512 may be generated based on ‘transition system format’ and ‘reachability graph’ of the ‘workflow model’ 506. The ‘transition system format’ and ‘reachability graph’ of the ‘workflow model’ 506 may be generated at the ‘application’ 512 before generation of the ‘monitor’ 512.

The generated ‘monitor’ 512 is referred as enforcement mechanism that ensures secure and complaint execution of the ‘workflow model’ 506 during runtime. Successful execution of the ‘workflow model’ 506 is achieved by complying with ‘authorization constraints’ 508 and ‘authorization policies’ 514. The ‘process designer’ 502 or an administrator may provide ‘authorization policies’ 514, e.g. {(t₁, A), (t₁, B), (t₁, C), (t₂, A), (t₂, B), (t₂, C), (t₃, A), (t₃, B), (t₄, B), (t₄. C), (t₅, A)}, corresponding to the ‘workflow model’ 506, either during design time or during runtime. The ‘authorization policies’ 514 may be changed during runtime. Therefore, the ‘authorization policies’ 514 may also act as runtime parameters provided to the ‘monitor’ 512 for executing the ‘workflow model’ 506. The ‘monitor’ 512 may use the ‘authorization policies’ 514 to ensure successful completion of each of the tasks (t₁) to (t₄) in the ‘workflow model’ 506 without violating the ‘authorization constraints’ 508. The reachability graph provides the knowledge of the possible workflow execution paths for successful execution of the ‘workflow model’ 506, i.e. executing each of the tasks (t₁) to (t₄) included in the ‘workflow model’ 506. Various illustrations explained above with respect to design time and runtime are merely exemplary. It should be appreciated that the processes may be executed completely in design time or completely in runtime or a combination of both.

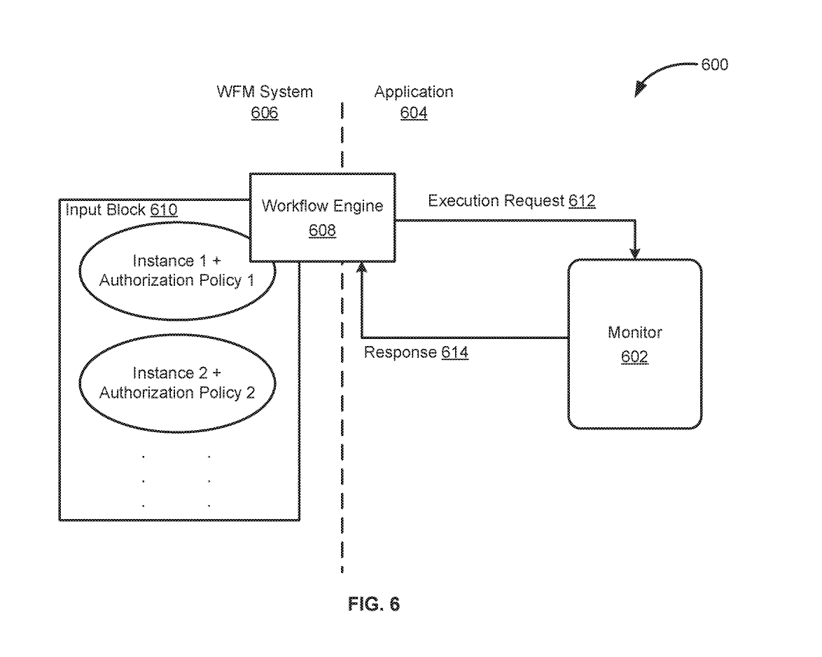

FIG. 6 is a flow diagram illustrating execution environment 600 implementing a monitor during runtime to ensure secure and compliant execution of process, according to one embodiment. ‘Monitor’ 602 may be referred as enforcement mechanism that may enforce authorization constraints and authorization policies for successful execution of processes during runtime. The ‘monitor’ 602 of the ‘application’ 604 may be generated during design time based on ‘workflow model’ of a process received from the ‘WFM system’ 606. The reachability graph may be translated in database query format to generate the ‘monitor’ 602. The ‘reachability graph’ includes all possible workflow execution paths and authorization constraints associated with the ‘workflow model’. The ‘reachability graph’ may be stored in ‘monitor repository’. The ‘reachability graph’ may include nodes that represent tasks executed by process participants and a set of edges that represent execution of tasks by process participants. For example, the ‘loan origination process’ includes four tasks such as ‘request loan (t₁)’, ‘evaluate external credit rating (t₂)’, ‘evaluate internal credit rating (t₃)’, and ‘approve loan (t4)’. ‘Workflow engine’ 608 may execute during the runtime.

The ‘WFM system’ 606 may include GUI (graphical user interface) connected with the ‘workflow engine’ 608. The GUI facilitates an authorized process participant to view instances of the tasks associated with the ‘workflow model’ that needs to be executed. The process participant may request for executing task (t) of an instance (i) associated with the ‘workflow model’ in the GUI. For example, in the ‘loan origination process’, ‘process participant A’ may request for executing the task ‘evaluate external credit rating (t₂)’ of ‘instance 1’. Instances may represent tasks associated with ‘workflow model’ that needs to be executed by the process participants. These instances may be generated by an administrator or a ‘process designer’. The ‘workflow engine’ 608 may receive ‘instances’ and authorization policies from an ‘input block’ 610. The ‘workflow engine’ 608 may invoke the ‘monitor’ 602 and enables the GUI to query the ‘monitor’ 602 to execute the requested task (t) for the instance (i) by the process participant. The GUI may query the ‘monitor’ 602 by sending ‘execution request’ 612. The ‘execution request’ 612 received at the ‘monitor’ 602 may include information to check if the ‘process participant A’ is allowed to execute the ‘request loan (t₁)’. Based on the ‘reachability graph’. ‘authorization constraints’ and the ‘authorization policies’ associated with the instance (i), the ‘monitor’ 602 may provide ‘response’ 614 either as “request grant” or “request deny” to the ‘workflow engine’ 608. For example, corresponding to ‘execution request’ 612 for ‘instance 1’, the ‘monitor’ 602 may send ‘response’ 614 “request grant” to allow ‘process participant A’ to execute the task ‘evaluate external credit rating (t₂)’. In another example, in ‘instance 2’, after successful execution of the ‘evaluate external credit rating (t₂)’, the ‘process participant A’ may request for executing the task ‘evaluate internal credit rating (t₃)’. The ‘monitor’ 602 may send ‘response’ 614 “request deny” to prevent ‘process participant A’ from executing task ‘evaluate internal credit rating (t₃)’. Therefore, the ‘monitor’ 602 ensures secure and compliant execution of the processes associated with in-memory database during runtime, without violating the ‘authorization constraints’, and also satisfying the ‘authorization policies’.

According to an exemplary embodiment, the ‘monitor’ 602 may be the translated version of the ‘reachability graph’ in SQL format stored in the ‘monitor repository’. The ‘monitor’ 602 may be invoked by the ‘workflow engine’ 608 to provide ‘response’ 614 either as “request grant” or “request deny”. For example, consider ‘process participant’ represented by symbol ‘u’ may request execution of a task represented by symbol ‘T’. This may be represented by a mathematical function: execute (u, T). The ‘workflow engine’ 608 may invoke the ‘monitor’ 602 to query the ‘reachability graph’ by enforcing the ‘authorization constraints’ and the ‘authorization policies’. The ‘monitor’ 602 may provide “request grant” or “request deny” to the ‘process participant (u)’. Below is an excerpt of the ‘monitor’ 602 for the ‘loan origination process’ in SQL query format, as an example, to enforce the authorization policies and authorization constraints:

SELECT U2.ID FROM PROCESS USERS AS U1, USERS AS U2 WHERE HST.dt1=1 AND HST.dt2=0, HST.dt3=1 AND HST.dt4=0 AND (U1.ID < > U2.ID) AND NOT HST.t3by=U1.ID AND NOT HST.t3by=U2.ID AND U1.ID IN (SELECT ID2 FROM PROCESS_PARTICIPANT_B) AND U2.ID IN (SELECT ID4 FROM PROCESS_PARTICIPANT_D)

In the abovementioned SQL query, to execute task (t₂), the ‘monitor’ 602 may have allowed execution of the task (t₁) and task (t₃) but not task (t₂) and task (4). This is mentioned as “HST.dt1=1 AND HST.dt2=0, HST.dt3=1 AND HST.dt4=0” in the query. The syntax “HST.dt1” represents execution history of the task (t₁). The ‘process participant U1’ and ‘process participant U2’ may be authorized to execute the tasks (t₂) and task (t₄), and also satisfies the ‘authorization constraints’ and ‘authorization policies’. The ‘authorization constraints’ such as SoD constraints may be mentioned as “NOT HST.t3by=U1.ID AND NOT HST.t3by=U2.ID”, in the SQL query. These SoD constraints may exist between the tasks (t₂) and (t₃) and between the tasks (t₃) and (t₄). The ‘process participant U1’ may execute the task (t₂) as the ‘ID2’ is selected from table ‘PROCESS_PARTICIPANT_B’ table and ‘process participant U2’ may execute the task (t₄) as the ‘ID4’ is selected from table ‘PROCESS_PARTICIPANT_D’.

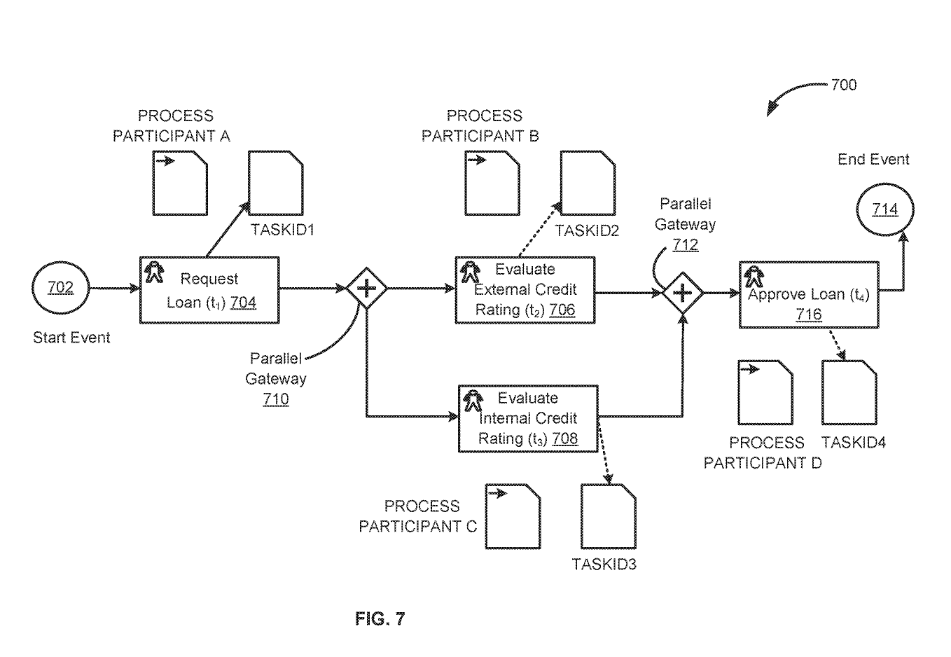

FIG. 7 is a flow diagram illustrating generation of a workflow model by a process designer during design time, according to one embodiment. During design time, the ‘process designer’ may ‘start event’ 702 to generate the ‘workflow model’ 700. The ‘process designer’ may also provide the ‘authorization constraints’ to the ‘workflow model’ 700. For example, ‘loan origination process’ include tasks such as ‘request loan (t₁)’ 704, ‘evaluate external credit rating (t₂)’ 706, and ‘evaluate internal credit rating (t₃)’ 708. The ‘process designer’ may also provide ‘authorization constraints’ between the tasks (t₂) and (t₃), and between the tasks (t₃) and (t₄). For example, if a ‘process participant’ has executed the task (t₂), then the ‘process participant’ may be prevented from executing the task (t₃). There are provided parallel gateways 710 and 712 before and after the tasks ‘evaluate external credit rating (t₂)’ 706 and ‘evaluate internal credit rating (t₃)’ 708. The parallel gateways 710 and 712 are represented symbol ‘+’ and allow execution of the tasks (t₂) and (t₃) in any order. For example, ‘evaluate external credit rating (t₂)’ 706 may be executed prior to ‘evaluate internal credit rating (t₃)’ 708 during runtime, and vice versa.

An administrator or the ‘process designer’ may specify ‘authorization policies’ in a user interface by linking each of the tasks (t₁ to t₄) to corresponding process participants. The tasks (t₁ to t₄) may be represented by respective task identifiers such as, e.g. ‘taskid1’, ‘taskid2’, ‘taskid3’ and ‘taskid4’. For example, ‘process designer’ may link ‘process participant A’, ‘process participant B’, ‘process participant C’ and ‘process participant D’ with the respective tasks identifiers ‘taskid1’ to ‘taskid4’, in the ‘workflow model’ 700. The ‘taskid1’ represents ‘request loan (t₁)’ 704, ‘taskid2’ represents ‘evaluate external credit rating (t₂)’ 706 and ‘taskid3’ represents ‘evaluate internal credit rating (t₃)’ 708 and ‘taskid4’ represents ‘approve loan (t₄)’ 716, in the ‘workflow model’ 700. The ‘authorization policies’ may be deployed during runtime. A ‘reachability graph’ may be generated for the ‘workflow model’ 700 based on backward reachability procedures. The ‘reachability graph’ may include possible workflow execution paths for the ‘workflow model’ 700.

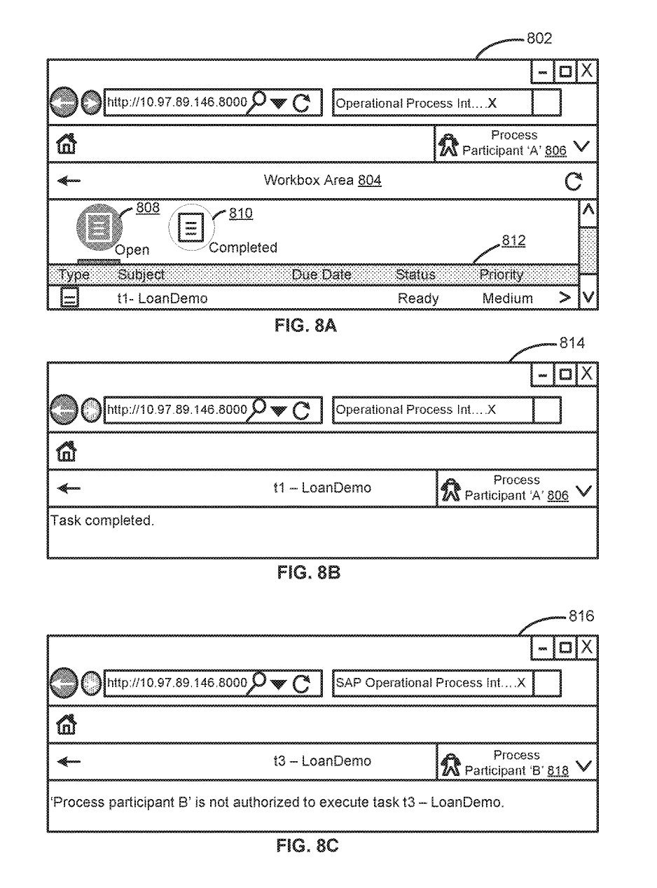

FIG. 8A-8C in combination are graphical user interfaces (GUI's) illustrating status of execution of processes at runtime, according to one embodiment. During runtime, when a request is received from ‘process participant’ to execute one of the tasks associated with ‘workflow model’ of a process in GUI, ‘workflow engine’ may invoke ‘monitor’ to provide a response such as “request grant” or “request deny” in the GUI. For example, in the ‘loan origination process’, ‘process participant U’ may be requested to execute task ‘evaluate external credit rating (t₂)’ of an ‘instance (i)’. The GUI connected with the ‘workflow engine’, query the ‘monitor’ based on the authorization policies and authorization constraints whether to provide “request grant” or “request deny” to the ‘process participant U’.

FIG. 8A illustrates GUI 802 that shows listing of tasks in ‘workbox area’ 804 that are assigned to a ‘process participant A’ 806. The ‘process participant A’ 806 may be able to view tasks by accessing the option ‘open’ 808 and ‘completed’ 810. The tasks may be displayed in a section referenced by the numeral 812 on the GUI. For example, if option ‘open’ 808 is selected then all the pending tasks are displayed in the section 812 along with the information such as type, subject, due data, status, priority, etc. As shown in FIG. 8A, the task (t₁) ‘LoanDemo’ is pending for the ‘process participant A’ 806. During runtime, the ‘process participant A’ 806 may request to execute the task (t₁) ‘LoanDemo’ in the GUI 802. The ‘monitor’ may be invoked by the ‘workflow engine’ to enforce the ‘authorization constraints’ and ‘authorization policies’ to provide “request grant” or “request deny” to the ‘process participant A’ 806. The ‘monitor’ may be queried to determine if the ‘process participant A’ is allowed to execute the task (t₁) ‘LoanDemo’. FIG. 8B illustrates GUI 814 that shows the ‘process participant A’ 806 may receive response as “request grant” to execute and complete the task (t₁) ‘LoanDemo’, from the ‘monitor’. A task complete message may be displayed in the GUI 814 for the ‘process participant’ 806.

FIG. 8C illustrates GUI 816 that shows a ‘process participant B’ 818 may request to execute the task (t₃) ‘LoanDemo’ in the GUI 816. The ‘monitor’ may be invoked by the ‘workflow engine’ to enforce the ‘authorization constraints’ and ‘authorization policies’ to provide “request grant” or “request deny” to the ‘process participant B’ 818. The ‘process participant B’ 818 may receive response as “request deny” to execute and complete the task (t₃) ‘LoanDemo’, from the ‘monitor’. A message “Process participant ‘B’ is not authorized to execute task (t₃)—LoanDemo” is displayed in the GUI 816 for the ‘process participant B’ 818.

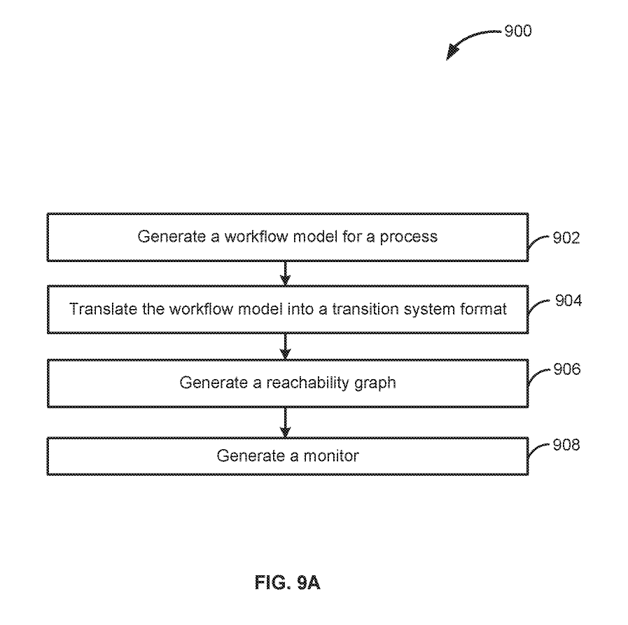

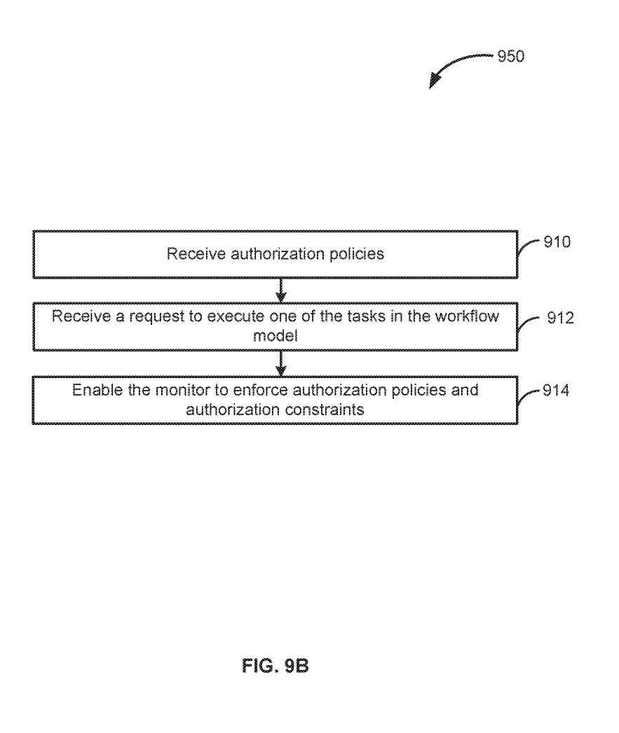

FIG. 9A is a flow diagram 900 illustrating generation of a monitor at design time, according to one embodiment. At 902, a workflow model is generated for a process associated with in-memory database. The workflow model include tasks and authorization constraints. At 904, the workflow model is translated into a transition system format. The transition system format may be a graphical representation of the workflow model that represents tasks as transitions. At 906, a reachability graph is generated that include workflow execution paths corresponding to the workflow model. The workflow execution paths include nodes representing states and edges representing tasks executed by process participants. The reachability graph is generated based on backward reachability procedures that has the ability to trace a workflow execution path from an initial state to a final state. At 908, a monitor is generated by translating the reachability in database query format.

FIG. 9B is a flow diagram 950 illustrating secure and complaint execution of a process by enforcing authorization constraints and authorization policies at runtime, according to one embodiment. At 910, authorization policies are received from a process designer at runtime. The authorization policies may include assignment of process participants to execute specific tasks. At 912, a request is received from a process participant to execute one of the task in the workflow model of the process. At 914, based on the reachability graph generated, the monitor is enabled to enforce authorization constraints and authorization policies to provide request grant or deny to execute the requested task.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

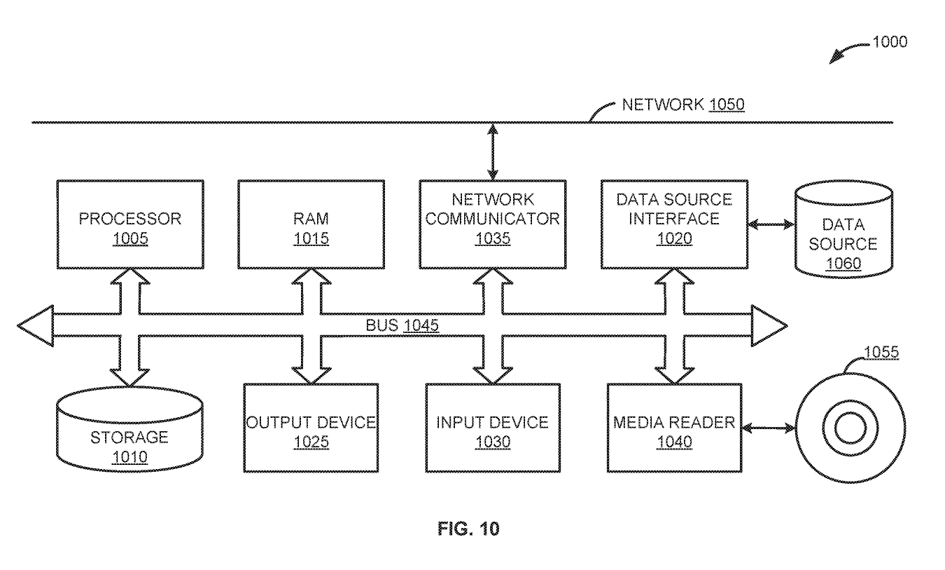

FIG. 10 is a block diagram of an exemplary computer system 1000, according to one embodiment. The computer system 1000 includes a processor 1005 that executes software instructions or code stored on a computer readable storage medium 1055 to perform the above-illustrated methods. The processor 1005 can include a plurality of cores. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. According to some embodiments, such as some in-memory computing system embodiments, the RAM 1015 can have sufficient storage capacity to store much of the data required for processing in the RAM 1015 instead of in the storage 1010. In some embodiments, all of the data required for processing may be stored in the RAM 1015. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for secure and compliant execution of processes associated with in-memory database, the method comprising:
generating a workflow model for a process associated with the in-memory database, wherein the workflow model include tasks and authorization constraints;
translating the workflow model into a transition system format;
generating a reachability graph that includes workflow execution paths corresponding to the workflow model, wherein the workflow execution paths include nodes representing states and edges representing tasks executed by process participants;
generating a monitor by translating the reachability graph in a database query format;
receiving authorization policies;
receiving a request to execute one of the task in the workflow model of the process; and
based on the reachability graph generated, enabling the monitor to enforce authorization constraints and authorization policies to provide request grant or deny to execute the requested task.

2. The method of claim 1, wherein the authorization constraints are task based constraints, and wherein the number of process participants required to execute the task is less than equal to the numbers tasks in the workflow model.

3. The method of claim 1, wherein generating the reachability graph is based on backward reachability procedures, and the reachability graph is able to trace a workflow execution path from an initial state to a final state.

4. The method of claim 1, wherein the authorization policies comprises assignment of process participants to execute a task of the workflow model.

5. The method of claim 1, wherein the request is received from a process participant to execute the one of the tasks in the workflow model of the process.

6. The method claim 1, wherein the transition format is a graphical representation of the workflow model that represents the tasks as transitions.

7. The method claim 1, wherein the method further comprises:
based on the database query format of the monitor, enabling the monitor to query the reachability graph based on authorization constraints and authorization policies to provide request grant or deny to execute the requested task.

8. A computer system for secure and compliant execution of processes associated with in-memory database, comprising:
generate a workflow model for a process associated with the in-memory database, wherein the workflow model include tasks and authorization constraints;
translate the workflow model into a transition system format;
generate a reachability graph that include workflow execution paths corresponding to the workflow model, wherein workflow execution paths include nodes representing states and edges representing tasks executed by process participants; and
translate the reachability graph in a database query format to generate a monitor.

9. The system of claim 8, the system further comprises:
receive authorization policies;
receive a request to execute one of the task in the workflow model of the process; and
based on the reachability graph generated, enable the monitor to enforce authorization constraints and authorization policies to provide request grant or deny to execute the requested task.

10. The system of claim 8, wherein the authorization constraints are task based constraints, wherein the number of process participants required to execute the task is less than equal to the numbers tasks in the workflow model.

11. The system of claim 8, further comprising instructions which when executed by the computer further causes the computer to:
generate the reachability graph is based on backward reachability procedures, and the reachability graph is able to trace a workflow execution path from an initial state to a final state.

12. The system of claim 8, wherein the authorization policies comprise assignment of process participants to execute a task of the workflow model.

13. The system of claim 8, wherein the request is received from a process participant to execute the one of the tasks in the workflow model of the process.

14. The system claim 8, wherein the transition format is a graphical representation of the workflow model that represents the tasks as transitions.

15. A non-transitory computer readable medium to store instructions, which when executed by a computer, causes the computer to perform operations comprising:
generate a workflow model for a process associated with the in-memory database, wherein the workflow model include tasks and authorization constraints;
translate the workflow model into a transition system format;
generate a reachability graph that include workflow execution paths corresponding to the workflow model, wherein the workflow execution paths include nodes representing states and edges representing tasks executed by process participants; and
translate the reachability graph in a database query format to generate a monitor;
receive authorization policies;
receive a request to execute one of the task in the workflow model of the process; and
based on the reachability graph generated, enable the monitor to enforce authorization constraints and authorization policies to provide request grant or deny to execute the requested task.

16. The computer-readable medium of claim 15, wherein the authorization constraints are task based constraints, wherein the number of process participants required to execute the task is less than equal to the numbers tasks in the workflow model.

17. The computer-readable medium of claim 15, further comprising instructions which when executed by the computer further causes the computer to:
generate the reachability graph is based on backward reachability procedures, and the reachability graph is able to trace a workflow execution path from an initial state to a final state.

18. The computer-readable medium of claim 15, wherein the authorization policies comprises assignment of process participants to execute a task of the workflow model.

19. The computer-readable medium of claim 15, wherein the request is received from a process participant to execute the one of the tasks in the workflow model of the process.

20. The computer-readable medium claim 15, wherein the transition format is a graphical representation of the workflow model that represents the tasks as transitions.
